(19) United States
(12) Patent Application Publication
(10) Pub. No.: US 2024/0284989 A1
(43) Pub. Date: Aug. 29, 2024

(54) HEAT-NOT-BURN CAPSULE, MATERIAL AND PREPARATION OF HEAT-NOT-BURN CAPSULE, DIPPING MOLD, AND PRODUCTION DEVICE

(71) Applicant: Altria Client Services LLC, Richmond, VA (US)

(72) Inventors: Yuan LIANG, Richmond, VA (US); Chunfei RU, Richmond, VA (US)

(73) Assignee: Altria Client Services LLC, Richmond, VA (US)

(21) Appl. No.: 18/572,327

(22) PCT Filed: Jun. 30, 2022
(86) PCT No.: PCT/US2022/035658

§ 371 Date: Dec. 20, 2023

(30) Foreign Application Priority Data
Jul. 2, 2021 (CN) 2021107501078
Jul. 2, 2021 (CN) 2021107510950
Jul. 2, 2021 (CN) 2021107510965
Jul. 2, 2021 (CN) 2021107511046
Jun. 22, 2022 (CN) 2022107135733

(51) Int. Cl. A24F 40/70; A24F 40/20; A24F 40/485; C08B 1/00; C08L 1/02

(52) U.S. Cl. CPC A24F 40/70; A24F 40/20; A24F 40/485; C08B 1/003; C08L 1/02; C08L 2205/025

(57) ABSTRACT

A heat-not-burn cigarette comprises a housing and an inner core. The head end of the housing is enclosed, and the tail end of the housing can receive the inner core. The inner core comprises a front insertion segment with an enclosed end, a rear insertion segment with an open end, and a tobacco containing space is defined between the end of the front insertion segment and the head end of the housing. A ventilation clearance is provided between an outer wall of the front insertion segment and an inner wall of the housing. A plurality of inlet holes are arranged in a side wall of the housing to communicate with the ventilation clearance, and a plurality of vent holes are provided on the end of the front insertion segment of the inner core.

### CROSS-REFERENCE TO RELATED APPLICATIONS

The present application is a national stage of International Application No. PCT/US2022/035658, filed Jun. 30, 2022, which claims priority to CN Appl. No. 202110751104.6, filed Jul. 2, 2021; CN Appl. No. 202110750107.8, filed Jul. 2, 2021; CN Appl. No. 202110751096.5, filed Jul. 2, 2021; CN Appl. No. 202110751095.0, filed Jul. 2, 2021; and CN Appl. No. 202210713573.3, filed Jun. 22, 2022, the entire contents of each of which are hereby incorporated herein by reference.

### BACKGROUND

### Field

The invention relates to the technical field of cigarettes/capsules and dipping production, in particular to a material for a heat-not-burn cigarette/capsule housing and a manufacturing method for the cigarette/capsule housing, a new heat-not-burn cigarette/capsule, a dipping mold, and a multiple continuous dipping device.

### Description of Related Art

Presently, cigarettes are the most common tobacco consumption articles. When the tobacco shred of the cigarette is burned, the aerosol is generated with nicotine, tobacco decomposing substance, spice and etc. wherein nicotine is the main sensory component for smokers. When conventional cigarettes release nicotine, the aerosol contains a plurality of harmful substances, such as carbonic oxide, crotonaldehyde, nitrosamine (TSNAs) and benzopyrene specialized in tobacco and etc., generated during burning and decomposing, the harmful substances are harmful to human's health.

Electronic cigarettes have been developed rapidly these years. The electronic cigarette heats and atomizes the liquid tobacco oil or semisolid tobacco paste by heating wires, and the electronic cigarette is an electronic product imitating cigarette, having the same design, smoke, taste and feeling as cigarettes. The electronic cigarette is an electronic atomizer powered by a rechargeable lithium polymer battery, and the electronic cigarette heats the tobacco oil in the heating chamber, vaporizes nicotine and provides smoke to smokers.

Research has revealed that smoke generated by heating but not burning contains harmful substances 80% less than the harmful substance from conventional cigarettes. Because the heating temperature is much lower than the burning temperature of tobacco, the release of harmful substances is greatly restricted. Therefore, the means for heating but not burning the tobacco has attracted attention from all parties, which can reduce the harm to smokers.

### SUMMARY

### Embodiment 1

The purpose of the present invention is to provide a material for a non-combustible, heatable, new-type of heat-not-burn cigarette housing and a manufacturing method for the cigarette housing. After loading tobacco shred in the housing, the heat-not-burn cigarette can be used as a constitute of cigarettes and heat the tobacco by a heater, the smoke generated by heating is provided to smokers, the harmful substance in the smoke is much lower than the harmful substance generated by the conventional tobacco during burning. The harm to a smoker and the surrounding environment is reduced while the smoker's experience is ensured.

To achieve the above purpose, the present invention provides the following technical solutions:

A material for a heat-not-burn cigarette housing comprises the following material components: plant cellulose and microcrystalline cellulose, wherein a weight proportion between the plant cellulose and the microcrystalline cellulose is 10:1 to 80:1. The plant cellulose and the microcrystalline cellulose in a proportion are mixed to form a mixture, taking 10 parts by weight of the mixture and putting the mixture into a 50 parts by weight of water heated to 90° C., stirring it and keeping it warm by a homogenizer for 1 hour, standing it still under a temperature of 30 to 60° C. for 2 hours thereafter, then adding 50 parts by weight of 99% alcohol, and homogeneously dissolving it again to form a liquid material for the housing.

In the present invention, the mixture of plant cellulose (HPMC) and microcrystalline cellulose is used as a manufacturing material for a heat-not-burn cigarette housing. The heat-not-burn cigarette housing manufactured by the material can withstand high temperature of 350° C. and the defects such as carbonization and air leakage will not occur. If the housing is only made of plant cellulose, the housing can ensure that the defects such as carbonization and air leakage will not occur at a temperature of no more than 200° C. If the tobacco is heated at temperature of lower than 200° C., the generate smoke is too small to bring a good experience to the smoker, and the cigarette housing made only of plant cellulose cannot replace the conventional cigarette. The tobacco heated at a temperature of about 300° C. may generate a smoke similar with the smoke generated by burning and bring a better experience to the smoker.

A manufacturing method for a heat-not-burn cigarette housing, the housing is tubular, the head of the housing is enclosed, the tail end of the housing is open, the housing is manufactured by dipping several times using a gel dipping mold and then processed, the method comprises following steps:

Preparing a gel dipping mold made of silicone, an outer surface of the gel dipping mold is configured corresponding to an inner wall of the housing, a fixing end and a blind hole are arranged in the tail of the gel dipping mold, the blind hole extends into the gel dipping mold throughout the fixing end, a pluggable hard core rod arranged in the blind hole, a tail end of the hard core rod is positioned outside of the gel dipping mold:
Preparing a liquid material for the housing;
Dipping, putting the gel dipping mold into the liquid material for the housing, then taking out the gel dipping mold and drying and solidifying the gel dipping mold through a dehumidifier to form the housing;
Repeating dipping, putting the gel dipping mold into the liquid material for the housing again when the material for the housing on the outside of the gel dipping mold is solidified, and then taking out the gel dipping mold and drying and solidifying the gel dipping mold through the dehumidifier to thicken the housing;
Repeating the step of repeating dipping for at least one time;
Demolding, securing the fixing end of the gel dipping mold, pushing the hard core rod towards the blind hole, the gel dipping mold generating deforming elongation while an outer diameter is decreased by a pressure of the hard core rod, wherein the housing formed on the outside of the gel dipping mold does not deform with the gel dipping mold so that the housing is demolded from the gel dipping mold;
Cutting the housing by a laser to remove a redundant length of the housing and perforating on a designated position of the housing.

The housing of the present invention is manufactured by dipping several times using the gel dipping mold and then processed to shape, the size of the housing is similar with the common cigarette, and the thickness of the housing is about 0.1 mm. The present invention manufactures the gel dipping mold using an extendably deformable elastic material, silicone. The blind hole and the hard core rod are arranged in the gel dipping mold, the gel dipping mold is dried and solidified to form the housing after dipping every times. When demolding, the fixing end (e.g. bump) of the gel dipping mold is secured, for example the gel dipping mold is traversed through the fixing plate and the fixing end of the gel dipping mold is not traversed through the fixing plate, and the fixing end of the gel dipping mold is pressed by a pressing plate with holes, then the gel dipping mold is pressed by pushing towards the hard core rod the blind hole such that the gel dipping mold is stretched and becomes thin, while the elasticity of the housing material is poor and will not become thin as the gel dipping mold is stretched, thereby the housing can be demolded from the gel dipping mold; The housing in the present invention is light, thin and suitable for processing by a laser.

Preferably, the housing comprises an outer sleeve and an inner core, the outer sleeve is tubular, a head end of the ouster sleeve is enclosed, a tail end of the outer sleeve receives an inner core to be inserted, the inner core is tubular, the inner core comprises a front insertion segment having an enclosed end, a rear insertion segment having an open end, a tobacco containing space is defined between the end of the front insertion segment and the head end of the outer sleeve, an ventilation clearance is defined between an outer wall of the front insertion segment and an inner wall of the outer sleeve, an outer surface of the rear insertion segment closely fits the inner wall of the outer sleeve, a plurality of inlet ports are arranged on a side wall of the outer sleeve to communicate with the ventilation clearance, a plurality of vent holes are disposed on the end of the front insertion segment of the inner core, wherein the inlet ports, the ventilation clearance, the vent holes, a conduit of the inner core and the end of the rear insertion segment of the inner core form a smoke channel.

In the present invention, the new cigarette composes of an outer sleeve in a shape of thin tube and an inner core. The outer sleeve and the inner core are manufactured by dipping several times using a gel dipping mold, and then processed to be formed; The inner core is inserted into and fixed in the outer sleeve, the tobacco shred is placed in the tobacco containing space, the inner core and a rear end of the outer sleeve are used as suction nozzle, the inlet port on the outer sleeve does not directly communicate with the suction nozzle (an outer surface of the rear insertion segment closely fits the inner wall of the outer sleeve enclosing), the inlet port needs to communicate with the suction nozzle through the smoke channel; When using a product of the invention, a heater should be used together with the product, a cigarette head composing of the outer sleeve and the inner core is inserted into tubular heating chamber of the heater, the tobacco containing space is totally inserted into the heater, heater is switched on to heat the tobacco, the heating temperature is 230-350° C., when the smoker sucks, the air enters into the tobacco containing space through the inlet port and the ventilation clearance, and carries the smoke generated from the heated tobacco through the vent hole, the conduit of the inner core, and the end of the rear insertion segment of the inner core, and then the air carrying the smoke is sucked by the smoker. The smoke temperature is lower than the normal body temperature, because the supplemented cool air can reduce the temperature of the head end and the smoke channel.

Preferably, an outer side surface of the rear insertion segment of the inner core closely fits the inner side wall of the outer sleeve through lock screw thread, wherein the lock screw thread comprises a first groove and a second groove respectively disposed in the inner core and the outer sleeve, and an inner side surface of the first groove fits an outer side surface of the second groove by shape. In the present invention, the inner core and the outer sleeve is enclosed by lock screw thread, the first groove and the second groove recess towards a same direction, when the inner core is inserted into the outer sleeve, recessions of two grooves are closely fit with each other such that the inner core and the outer sleeve are fixedly positioned and enclosed the ventilation clearance; the numbers of the first groove and the second groove are not limited to one, it may be two or three.

Preferably, in the liquid material for the housing, a weight proportion between the plant cellulose and the microcrystalline cellulose is 50:1, taking 1 kg of a mixture of the plant cellulose and the microcrystalline cellulose and adding the mixture into 5 kg of water at 90° C., placing it in a homogenizer and stirring it for 1 hour while keeping it warm, standing still for 2 hours at a temperature of 45° C. after completion, then adding 5 kg of 99% alcohol, and homogeneously dissolving again to form the liquid material for the housing.

Preferably, the step of repeating dipping is performed for 5 times, and the housing is thickened for 0.02 mm every time.

Preferably, a plurality of gel dipping molds are together fixed on a mold fixing plate, wherein the tail end of the hard core rod is positioned outside of the mold fixing plate.

Preferably, the outer sleeve and the inner core are transparent tubes.

Compared with the prior arts, the beneficial effects of the present invention are: the heatable new heat-not-burn cigarette can be used as a substitute of cigarettes, and by heating but not burning the tobacco, the smoke generated by heating can be provided to the smoker, and the smoke contains harmful substance much lower than the amount of harmful substance contained in the smoke generated after burning. The harm to a smoker and the surrounding environment is reduced while the smoker experience is ensured.

### Embodiment 2

The purpose of the present invention is to provide a material for a non-combustible, heatable, new heat-not-burn cigarette as constitute of cigarette. The heat-not-burn cigarette of the present invention is used with a heater, tobacco shred is heated, and the smoke generated after heating is provided to smokers. The amount of harmful substance in the smoke is much lower than the harmful substance generated by the conventional tobacco during burning. The harm to a smoker and the surrounding environment is reduced while the smoker experience is ensured.

To achieve the above purpose, the present invention provides the following technical solutions:

A new heat-not-burn cigarette comprises a housing and an inner core, the housing is tubular, a head end of the housing is enclosed, a tail end of the housing receives an inner core to be inserted, the inner core is tubular, the inner core comprises a front insertion segment with an enclosed end, a rear insertion segment with an open end, a tobacco containing space is defined between the end of the front insertion segment and the head end of the housing, an ventilation clearance is defined between an outer wall of the front insertion segment and an inner wall of the housing, an outer surface of the rear insertion segment closely fits the inner wall of the housing, a plurality of inlet holes are provided in a side wall of the housing to communicate with the ventilation clearance, a plurality of vent holes are provided on the end of the front insertion segment of the inner core, wherein the inlet holes, the ventilation clearance, the vent holes, a conduit of the inner core and the end of the rear insertion segment of the inner core form a smoke channel.

In the present invention, the new cigarette composed of a housing in a shape of thin tube and an inner core. The inner core is inserted into and secured in the housing, the tobacco shred is placed in the tobacco containing space, the inner core and a rear end of the housing are used as suction nozzle, the inlet hole on the housing does not directly communicate with the suction nozzle (an outer surface of the rear insertion segment closely fits the inner wall of the outer sleeve enclosing), the inlet hole needs to communicate with the suction nozzle through the smoke channel: When using a product of the present invention, a heater should be used together with the product, a cigarette head composing of the housing and the inner core is inserted into tubular heating chamber of the heater, the tobacco containing space is totally inserted into the heater, the heated is switched on to heat the tobacco, the heating temperature is 230-350° C., when the smoker sucks, the air enters into the tobacco containing space through the inlet hole and the ventilation clearance, and carries the smoke generated from the heated tobacco through the vent holes, the conduit of the inner core and the end of the rear insertion segment of the inner core, and then the air carrying the smoke is sucked by the smoker. The smoke temperature is lower than the normal body temperature, because the supplemented cool air may lower the temperature of the head end and the smoke channel.

Preferably, the housing comprises a heating portion at the head end and a hand-held portion at the tail end, and the heating portion is fixedly connected with the hand-held portion. The heating portion needs to withstand the heating temperature, while the hand-held portion is little influenced during heating. In order to save materials, the heating portion can be made of heat-resistant materials, and the hand-held portion can be made of common materials, the heating portion and the hand-held portion are adhered with each other or secured by other means.

Preferably, a front end of the heating portion of the housing is provided with a hemispherical head cover, and an outside of the hand-held portion is covered with a packing layer. The hemispherical head cover is not easy to crack, and may be better co-used with the heater: The out surface of the hand-held portion is covered with the packing layer, on one hand the packing layer protects the housing, on the other hand the packing layer makes the design of the heat-not-burn cigarette similar with common cigarettes, the packing layer can only cover the hand-held portion, the packing layer can also cover the heating portion together with the hand-held portion.

Preferably, an end of the front insertion segment of the inner core is provided with a hollow tube tip extending forward, and a tip of the hollow tube tip is provided with a plurality of vent holes. A tobacco containing space is defined between an end of the front insertion segment of the inner core and the head end of the housing, the smoke generated by the tobacco shred which is away from the end of front insertion segment of the inner core is hard to suck, the present invention is provided with a hollow tube tip at the end of the front insertion segment of the inner core, and the hollow tube tip can extend to an approximate of the head end of the housing. It is easy to suck the smoke generated by the tobacco near the tube tip with the vent holes of the tip of the tube tip.

Preferably, the front insertion segment of the inner core is a polygonal tube, and edges of the polygonal tube closely contact with the inner wall of the housing. In the present invention, the outer wall of the inner core clings to the inner wall of the housing for enclosing and securing. The polygonal tube of the front insertion segment of the inner core has protruding edges clinging to the inner wall of the housing, gaps between the outer wall among edges of the inner core and the inner wall of the housing works as an ventilation clearance, for example, the polygonal tube has a cross section of hexagon, six vertex angles clings to the housing, and there are gaps between the six edges of the hexagon and the housing, the gaps work as ventilation clearances.

Preferably, an outer side surface of the rear insertion segment of the inner core fits the inner side wall of the housing closely by a locking screw thread, the locking screw thread comprises a first groove and a second groove respectively disposed in the inner core and the housing, wherein an inner side surface of the first groove fits an outer side surface of the second groove by shape. In the present invention, the inner core and the housing is enclosed by locking screw thread, the first groove and the second groove recess towards a same direction, when the inner core is inserted into the housing, recessions of two grooves closely fits each other such that the inner core and the housing are fixedly positioned and enclose the ventilation clearances.

Preferably, the first groove and the second groove are annular grooves having arc-shaped cross-sections. In the present invention, the first groove and the second groove ring around the inner core or the housing, and a cross section of the ringed groove is an arc; the numbers of the first groove and the second groove are not limited to one, it can be two or three.

Preferably, a mouthpiece is provided at an opening of the rear insertion segment of the inner core. The mouthpiece may meet the experience of some smokers, and filter smoke to reduce the amount of harmful substance contained in the smoke, so that the harm to smoker is less.

Preferably, the housing and the inner core are transparent tubes.

Compared with the prior arts, the beneficial effects of the present invention are: the heatable new heat-not-burn cigarette can be used as a substitute of cigarettes, and it heats but burns the tobacco. The smoke generated after heating can be provided to the smoker, and the amount of harmful substance contained in the smoke is much lower than the amount of harmful substance contained in the smoke generated after burning. The harm to a smoker and the surrounding environment is reduced while the smoker experience is ensured.

### Embodiment 3

The purpose of the present invention is to provide a capsule mold for producing a new non-combustible, heatable, heat-not-burn cigarette housing, and the housing may contain tobacco shred and works as constitute of cigarettes. The heat-not-burn cigarette of the present invention is used with a heater, tobacco shred is heated, and the smoke generated by heating is provided to smokers. It is easy to manufacture and demold the capsule mold, and the capsule mold can be manufactured in an assembly line and has high production efficiency.

To achieve the above purpose, the present invention provides the following technical solutions:

A gel dipping mold comprises an extendable a silicone mold body and a core rod, the silicone mold body is elongated, the silicone mold body is provided with an axial long blind hole. One end of the silicone mold body is enclosed, and another end of the silicone mold body is open and communicates with the long blind hole. The open end of the silicone mold body comprises a mounting boss, an out diameter of the core rod is coupled to a diameter of the long blind hole. One end of the core rod is arranged in the long blind hole, and another end of the core rod is arranged outside of the silicone mold body.

Preferably, the silicone mold body is a silicone outer sleeve mold, the silicone outer sleeve mold has a shape of circular tube, and the enclosed end of the silicone outer sleeve mold is hemispheric.

Preferably, the silicone mold body is a silicone inner core mold. The silicone inner core mold comprises a circular tube segment connected with the open end and a polygon tube segment connected with the enclosed end. An end face of the enclosed end comprises a pointed cone segment extending outwardly along an axis direction.

Preferably, the capsule in a form of thin shell can be produced by gel dipping method. A part of the gel dipping mold is dipped into raw liquid gel material, the liquid gel is stuck to a surface of the gel dipping mold, and then the liquid gel is dried to form a semi-finished housing sticking to an outer surface of the gel dipping mold. And then the semi-finished housing is demolded, and post-processed to form a product. The present application adopts an inventive demolding structure. Firstly, the mold body of the gel dipping mold according to the present application is an extendable silicone mold body: secondly, a core rod is disposed in the mold body, and a tail end of the core end is disposed outside of the mold body. During demolding, it only necessary to push the core rod toward the blind hole of the mold body to secure the mold body and apply pressure. In the case where the mounting boss of the mold body is secured, the mold body extends along a direction away from the mounting boss. The length of the mold body is increased while the diameter of the mold body is accordingly decreased. Meanwhile, an adhesive power between the housing product (e.g., outer sleeve, inner core) coating on the outer surface of the silicone mold body and the mold body is overcome, thereby the housing product is separated from the mold body to realize demolding.

The gel dipping mold of the present application is used to produce an outer sleeve in a shape of thin tube and an inner core. A new cigarette is composed of the outer sleeve and the inner core, wherein the inner core is inserted into and secured in the housing. The tobacco shred is placed in a tobacco containing space defined between an internal head end of the outer sleeve and a head end of the inner core. A rear end of the inner core and a rear end of the outer sleeve are open, serving as a suction nozzle for the smoker. The sidewall of the outer sleeve is provided with an inlet hole that does not directly communicate with the suction nozzle (an outer surface of a rear insertion segment closely fits an inner wall of the outer sleeve for enclosing), the inlet hole is communicated with the suction nozzle through the tobacco containing space and the inner core. The air enters into the tobacco containing space through the inlet hole of the outer sleeve, wherein air carrying the smoke generated from the heated tobacco shred passes a conduit of the inner core and then is sucked. The temperature of the smoke therein is lower than a normal body temperature, because the supplemented cool air can lower the temperature of the head end of the outer sleeve and the smoke channel.

Preferably, the core rod is cylindrical, the circumferential side surface of the core rod is provided with a plurality of grooves having an orientation same as the axial direction and recessed inwardly. The core rod in the present application is a hard elongated rod, an end of the core rod abuts an internal bottom end of the blind hole of the mold body, and another end of the core rod protrudes beyond the mold body. While demolding, it is only necessary to apply an axial pressure to the end of the core rod that is outside of the mold body. The core rod abuts the mold body and stretches the elastic silicone mold body such that the thin shell product sticking to the surface of the silicone mold body is demolded from the silicone mold body. An arrangement of the grooves can reduce a frictional force between the core rod and the sidewall of the silicone mold, so it is easy to draw the core rod in and out of the silicone mold.

Preferably, the grooves comprise lubricating fillers (e.g., carbon dust) therein to reduce the frictional force between the core rod and a side wall of the blind hole of the silicone mold, so it is easy to draw the core rod in and out of the silicone mold.

Preferably, an outer surface of the silicone outer sleeve mold proximate to the open end comprises at least one annular groove.

Preferably, an outer surface of the circular tube segment comprises at least one annular groove.

In the present application, the silicone outer sleeve mold and the silicone inner core mold are respectively provided with annual grooves serving as lock screw threads. The two molds can closely fit with each other. The sealed engagement between the inner core and housing produced by mold is realized by the lock screw threads, and the grooves recess are oriented in the same direction. When the inner core is inserted into a housing, recessions of the two grooves closely fit with each other, such that the inner core and the housing is fixed for sealing.

Preferably, the gel dipping mold comprises a mold fixing mount, and the mold fixing mount comprises a fixing plate and a cover plate coupled with each other. A plurality of the mounting bosses of the silicone mold body is secured between the fixing plate and the cover plate, and one end of the core rod traverses the cover plate and is positioned out of the fixing mount. The mold fixing mount of the present application can be used in an assembly line in a massive production. By securing a lot of silicone molds on a mold fixing mount, there can be a plurality of mold fixing mounts in a production line to respectively process steps (such as gel dipping, drying and solidifying, demolding) according to an assembly line program.

Compared with the prior arts, the beneficial effects of the present invention are: the invention provides a capsule mold for manufacturing a new non-combustible, heatable, heat-not-burn cigarette housing, and it is easy to manufacture and demold the capsule mold. The housing can be manufactured in an assembly line with a high production efficiency.

### Embodiment 4

The problem to be solved by the present disclosure is the demolding of longer capsules during automatic production. The present application also provides a method for changing the structure of gel dipping mold and demolding, which realizes automatic production, makes the demolding process simple, and produces a multiple continuous gel dipping production device with a good demolding effect.

To achieve the above object, the invention provides the following technical solutions:

A multiple continuous gel dipping device comprising a drafting device, a multiple gel dipping device, a drying device, a tail lifting device, which are arranged in a straight line; also comprising a plurality of continuous conveying devices disposed between the respective devices, and a plurality of trays carrying gel-dipping molds; The gel-dipping mold includes a mold body and a core rod, the mold body is a strip-shaped retractable mold, including a fixed end, a dipping end, and a blind hole opening at the fixed end, and the fixed end is fixed on the tray, the gel dipping end is disposed on the outside of the tray, one end of the core rod is inserted into the blind hole, and the other end of the core rod is outside of the tray; and the drafting device includes a drafting rack including a tray lifting device therein, a receiving device is disposed at the bottom of the drafting rack, the tray lifting device includes a screw lifting device and a draft ejection device including a left ejection rack, a right ejection rack, and a draft ejection plate, two ends of the draft ejection plate are respectively fixed to the left ejection rack and the right ejection rack, the left ejection rack and the right ejection rack respectively includes guide posts, springs, and a draft ejection tray plate including a moving groove that is inserted at both two ends of the tray, the gel dipping end of the mold body is positioned below the tray when the tray is in the moving groove, the draft ejection tray plate is movably connected to the guide posts that pass through the springs, one end of the spring is closely fixed to the draft ejection tray plate, the receiving device is provided with an ejection device stopping rod, the draft ejection device includes working positions at the top and bottom of the screw lifting device respectively, wherein the tray is inserted into the moving groove when the draft ejection device is at the top of working position of the screw lifting device, and the draft ejection tray plate is held up by an ejection device stopping rod while the left ejection rack and the right ejection rack descend to reach a predetermined position when the draft ejection is lowered a working position at the bottom of the screw lifting device.

Thin-shell capsules can be produced by the gel dipping process. A part of the gel dipping mold is immersed in the material gel solution, and the gel solution adheres to the surface of the gel dipping mold. After drying, a semi-finished shell that fits the surface of the dipping mold can be formed, and then demold and post-processed to form products. The technical solution disclosed an inventive demolding structure. First, the mold body disclosed in the present application is a retractable mold, such as silicone and rubber. Second, the end of the core rod is outside of the mold body, when demolding, pushing, and applying the pressure the core rod to the blind hold of the mold body to hold the mold body. When the boss of the mold body is fixed, the mold body extends away from the boss, and the length of the mold body increases but the diameter correspondingly reduces. At this time, the adhesion force between the outer shell products, such as the jacket and the core and the mold body is destroyed to detach from the mold body to realize demolding. The present application relates to a new drafting device. The tray carrying the mold bodies enters from the upper end of the drafting machine to the drafting ejection device and then descends to the demolding working position together with the screw lifting device. At this time, the draft ejection tray plate is held up by an ejection device stopping rod until the left ejection rack and the right ejection rack descend. The draft ejection plate that is fixed on the left ejection rack and the right ejection rack is pressed to the upper end of the core rod of the mold body to make the core rod move downward, and the mold bodies extend downward, and the adhesion force between the product that is wrapped on the outer side of the silicone mold bodies and the mold bodies is destroyed to detach from the mold bodies and realize demolding.

Preferably, one side of the drafting rack includes a multiple gel dipping device, a drying device, and a tail lifting device. The multiple gel dipping device includes a gel dipping rack, a first gel dipping device, a second gel dipping device, a plurality of repeated gel dipping and lifting devices, and the first gel dipping device is disposed on the one side of the gel dipping rack near the drafting rack; the second gel dipping device is disposed on the side of the gel dipping rack away from the drafting rack, and the plurality of repeated gel dipping and lifting devices are disposed between the first gel dipping device and the second gel dipping device, and the first gel dipping device, the second gel dipping device, and the plurality of repeated gel dipping and lifting devices respectively include a tray pushing device; the drying device includes a drying rack including a multi-layer drying area, and the multiple-layer drying area corresponds to the first gel dipping device, the second gel dipping device, the plurality of repeated gel dipping and lifting devices layer by layer. The continuous conveying device includes multi-layer tracks, the first gel dipping device is connected to the drying area and the tail lifting device through the bottom track disposed at the bottom of the gel dipping rack and the drying rack, and the second gel dipping device and the plurality of repeated gel dipping and lift devices are respectively connected the drying area and the tail lifting device through an upper track and a lower track, a top track is provided at the top of the gel dipping rack and the drying rack, the trays with the plurality dipping gel is movably disposed on the multi-layer track; and the tail lifting device comprising a lifting rack including a tail tray lifting rack that moves up and down, and a tail tray pushing rack that moves left and right; the tail tray lifting rack includes a tray support assembly corresponding to multi-layer tracks.

In this scheme, the first gel dipping device, the second gel dipping device, multiple repeated gel dipping, and lifting devices, drying devices, and tail lifting devices are matched with the drafting device: That is, it is automatically transferred to the first gel dipping device, and then the mold body is dipped for the first time, and then the tray with the mold bodies enters the tail lifting device from the bottom track through the drying device, and the tail tray lifting rack will carry the mold body. The tray is lifted from the bottom track to the lower track matched with the second gel dipping device, and the tail tray pushing device moves the tray with the mold bodies from the lower track through the drying device to the second gel dipping device, and then the mold bodes are moved to carry out the second dipping, and after completion, the second dipping device sends the tray with the mold bodies to the upper track that is matched with the second gel dipping device, and the tray with the mold bodies will enter the tail lifting device from the upper track through the drying device. The tail tray lifting rack lifts the tray with the mold bodies from the upper track to the lower track that is matched with the gel dipping and lifting device at the lowest position among the multiple repeated dipping and lifting devices. The tray with the mold bodies is moved from the lower track to the dipping and lifting device through the drying device, and then the mold body is dipped once and then returned to the tail lifting device. After the device moves the tray with the mold bodies into the tail lifting device, the tail lifting device lifts the tray with the mold bodies to the top track position and pushes the tray with the mold bodies to the top of the draft machine to enter the draft. After demolding, the process of dipping and drying is carried out again for many times.

Preferably, the top of the drafting rack includes an extension arm extending outward, and the extension arm includes a top tray turning device and the top tray pushing device, the top tray turning device corresponds to the tail lifting device through the top track, and the top tray turning device turns the tray by 180 degrees so that the gel dipping end of the mold body is under the tray, the top tray pushing device moves the tray to the draft ejection tray plate: The multiple dipping device includes a first gel dipping device including a dipping rack under the extension arm, and the top of the dipping rack includes a tray translation device, wherein the tray translation device moves the tray from the draft ejection tray plate to the dipping rack when the ejection device on the ejection rack is at the bottom working position of the screw lifting device.

Preferably, the first gel dipping device includes a liftable gel reservoir, a tray translation device, a primary tray turning device, a tray lowering device, and a tray pushing device; the tray translation device includes a moving rod assembly that moves the tray from the draft ejection tray to position above the liftable gel reservoir, and at the same moves the other tray from the liftable gel reservoir to the primary tray turning device, the primary tray turning device turns the tray by 180 degrees so that the gel dipping end of the mold body is above the tray, and the tray lowering device moves the tray to the tray pushing device, the tray pushing device moves the tray to the bottom track; and one end of the bottom track is matched with the tray pushing device, and the other end is matched with the tail tray lifting rack through the drying area.

Preferably, the second gel dipping device includes a tray turning device, a tray translation device, a liftable gel reservoir, a secondary tray turning device, and a tray pushing device; the tail tray pushing rack moves the tray to the primary tray turning device through the lower track, and the primary feeding tray turning device turns the tray by 180 degrees to make the gel dipping end of the mold body under the tray: the tray translation device moves the tray to a position above the liftable gel reservoir, and at the same time moves the other tray from the top of the liftable gel reservoir to the secondary tray turning device, the secondary tray turning device turns the tray by 180 degrees so that the gel dipping end of the mold body is on the tray, and the tray pushing device moves the tray to the upper track; one end of the upper track is matched with the tray pushing device of the second gel dipping device, the other end of the upper track is arranged in cooperation with the tail tray lifting rack through the drying area, and one end of the lower track corresponds to the tail tray pushing rack, and the other end of the lower track passes through the drying area and corresponds to the primary tray turning device of the second gel dipping device.

Preferably, the plurality of repeated gel-dipping and lifting devices respectively comprise a tray turning device, a tray lowering device, a tray translation device, a liftable gel reservoir, a tray lifting device, a secondary tray turning device, a tray pushing device; and the tail tray pushing rack moves the tray to the primary tray turning device through the lower track, and the primary tray turning device turns the tray by 180 degrees so that the gel dipping end of the mold body is under the tray, and the tray lowering device lowers the tray to the tray translation device, the tray translation device moves the tray to a position above the liftable gel reservoir while the other tray moves from the position above the liftable gel reservoir to the tray lifting device, the tray lifting device lifts the tray to the secondary tray turning device, the secondary tray turning device turns the tray by 180 degrees so that the gel dipping end of the mold body is above the tray, and the tray pushing device moves the tray to the upper track: one end of the upper track is matched with the tray pushing device of the plurality of repeated gel dipping and lifting device, the other end of the upper track passes through the drying area and is matched with the tail tray lifting rack; one end of the bottom track corresponds to the tail tray pushing rack, the other end of the bottom track passes through the drying area and corresponds to the primary tray turning device of the plurality of the repeated gel dipping and lifting device.

Preferably, the plurality of repeated gel dipping and lifting devices includes three repeated gel dipping and lifting devices.

Preferably, the tail tray pushing rack includes a tail pushing rod assembly that corresponds to the top track, the second gel dipping device, the lower track of a plurality of repeated gel-dipping and lifting devices respectively: the corresponding connection between the lifting rack, the bottom track, and the upper track includes a fixed tray, the corresponding connection between the lifting rack, the lower track and the upper track includes a rotary, resettable rotary reset tray, and the tail tray lifting rack includes a rotary reset tray that is matched with the fixed tray and the rotating reset tray on the lifting rack: the tail tray lifting rack lifts the tray entered from the bottom track and the upper track to the corresponding the lower track or the top track of the upper layer, and the tail tray pushing rack pushes the tray into the lower track or the top track.

Preferably, the tray comprises a fixed plate and a cover plate that are matched with each other, and the fixed ends of a plurality of silicone mold bodies are fixed between the fixed plate and the cover plate, one end of the core rod passes through the cover plate to be outside of the tray.

Preferably, the receiving device includes guide wheels of the draft ejection device, a draft blanking box, and a draft outlet.

Compared with the prior art, the beneficial effects of the present invention are as follows: the present application provides a method for changing the structure of gel dipping mold and demolding, which realizes automatic production, makes the demolding process simple, and produces a multiple continuous gel dipping production device with a good demolding effect.

### BRIEF DESCRIPTION OF THE DRAWINGS

FIG. 1 is a structure diagram of the outer sleeve of the present invention.

FIG. 2 is a structure diagram of the inner core of the present invention.

FIG. 3 is a cross-sectional structure diagram of the present invention.

FIG. 4 is a structure diagram of the housing mold of the present invention.

FIG. 5 is a structure diagram of the inner core mold of the present invention.

FIG. 6 is a structure diagram of a housing of the present invention.

FIG. 7 is a structure diagram of an inner core of the present invention.

FIG. 8 is a cross-sectional structure diagram of the present invention.

FIG. 9 is a structure diagram of a silicone outer sleeve mold according to the present invention.

FIG. 10 is a structure diagram of a silicone inner core mold according to the present invention.

FIG. 11 is a structure diagram of a core rod according to the present invention.

FIG. 12 is a structure diagram of a mold fixing mount according to the present invention.

FIG. 13 is a schematic structural diagram of a gel dipping mold of the present application.

FIG. 14 is a schematic structural diagram of the gel dipping mold and a tray of the present application.

FIG. 15 is a schematic structural diagram of a multiple continuous gel dipping device of the present application.

FIG. 16 is a schematic structural diagram of a drafting device of the present application.

FIG. 17 is a schematic structural diagram of a draft ejection device of the drafting device of the present application.

FIG. 18 is a schematic structural diagram of a receiving device of the drafting device of the present application.

FIG. 19 is a schematic structural diagram of a first gel dipping device of the present application.

FIG. 20 is a schematic structural diagram of a second gel dipping device and a multiple gel dipping device of the present application.

FIG. 21 is a top view of FIG. 18.

FIG. 22 is a schematic structural diagram of a tail lifting device of the present application.

### IN THE FIGURES

2.1—housing
2.2—inner core
2.3—tobacco containing space
2.4—ventilation clearance
2.5—first groove
2.6—second groove
2.7—housing mold
2.8—inner core mold
2.9—fixing end
2.10—hard core rod
2.11—inlet port
2.21—front insertion segment
2.22—rear insertion segment
2.23—vent hole
3.1—housing
3.2—inner core
3.3—tobacco containing space
3.4—ventilation clearance
3.5—first groove
3.6—second groove
3.11—air inlet
3.12—heating portion
3.13—hand-held portion
3.14—hemispherical head cover
3.21—front insertion segment
3.22—rear insertion segment
3.23—vent hole
3.24—hollow tube tip
5.1—silicone mold body
5.2—core rod
5.3—mounting boss
5.4—mold fixing mount
5.11—silicone outer sleeve mold
5.12—annular groove
5.13—silicone inner core mold
5.41—fixing plate
5.42—cover plate
5.131—circular tube segment
5.132—polygon tube segment
5.133—pointed cone segment
15.1—drafting device
15.2—multiple gel dipping device
15.3—drying device
15.4—tail lifting device
15.5—continuous conveying device
15.6—gel dipping mold
15.7—tray
15.61—mold body
15.62—core rod
15.63—fixed end
15.64—dipping end
15.71—fixed plate
15.72—cover plate
15.101—drafting rack
15.102—receiving device
15.103—screw lifting device
15.104—draft ejection device
15.105—left ejection rack
15.106—right ejection rack
15.107—draft ejection plate
15.108—spring
15.109—draft ejection tray plate
15.110—moving groove
15.111—ejection device stopping rod
15.112—extension arm
15.113—top tray turning device
15.114—top tray pushing device
15.115—guide wheel
15.116—draft blanking box
15.117—draft outlet
15.201—gel dipping rack
15.202—first gel dipping device
15.203—second gel dipping device
15.204—repeated gel dipping and lifting device
15.205—tray pushing device
15.301—drying rack
15.401—lifting rack
15.402—tail tray lifting rack
15.403—tail tray push rack
15.501—bottom track
15.502—upper track
15.503—lower track
15.504—top track
15.2021—dipping frame
15.2022—tray translation device
15.2023—liftable gel reservoir
15.2024—primary tray turning device
15.2025—tray lowering device
15.2027—moving rod assembly
15.2031—primary tray turning device
15.2032—secondary tray turning device
15.2041—tray lowering device
15.2042—tray lifting device
15.4011—fixed tray plate
15.4012—rotary reset tray plate
15.4031—tail pushing rod assembly.

### DETAILED DESCRIPTION

The technical solutions in the embodiments of the present invention will be clearly and completely described below with reference to the appended drawings showing the embodiments of the present invention. Obviously, the described embodiments are only a part of the embodiments of the present invention, rather than all the embodiments. The embodiments of the present invention, and all other embodiments obtained by those of ordinary skill in the art without creative work, fall within the protection scope of the present invention.

### Embodiment 1

The present invention provides a technical solution:

A material for a heat-not-burn cigarette housing comprises the following material components: plant cellulose and microcrystalline cellulose, wherein a weight proportion between the plant cellulose and the microcrystalline cellulose is 10:1 to 80:1; mixing the plant cellulose and the microcrystalline cellulose in a proportion to form a mixture, taking 10 parts by weight of the mixture and putting it into 50 parts by weight of water heated to 90° C., stirring and keeping it warm by a homogenizer for 1 hour, standing it still for 2 hours at a temperature of 30 to 60° C. after completion, then adding 50 parts by weight of 99% alcohol, and homogeneously dissolving again to form a liquid material for the housing.

A manufacturing method for a heat-not-burn cigarette housing, the housing is tubular, the head of the housing is enclosed, the tail end of the housing is open, the housing is manufactured by dipping a gel dipping mold several times (i.e., dipping the liquid material for housing), and then the housing is processed to obtain a housing product.

In the liquid material for the housing, a weight proportion between the plant cellulose and the microcrystalline cellulose is 50:1, taking 1 kg of the mixture of the plant cellulose and the microcrystalline cellulose and adding the mixture into 5 kg of water at the temperature of 90° C., placing it in a homogenizer and stirring if for 1 hour while keeping it warm, standing it still for 2 hours at a temperature of 45° C. after completion, then adding 5 kg 99% alcohol, and homogeneously dissolving again to form the liquid material for the housing.

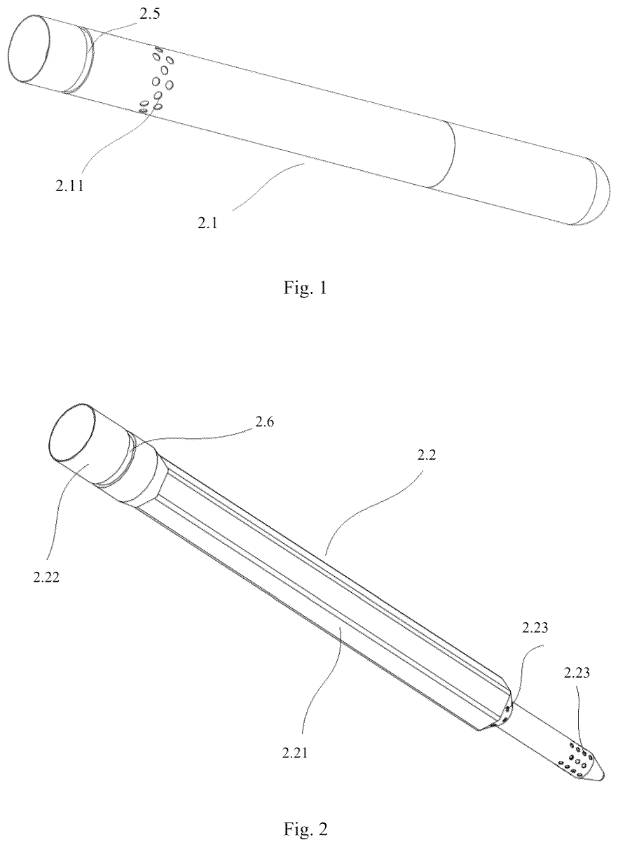

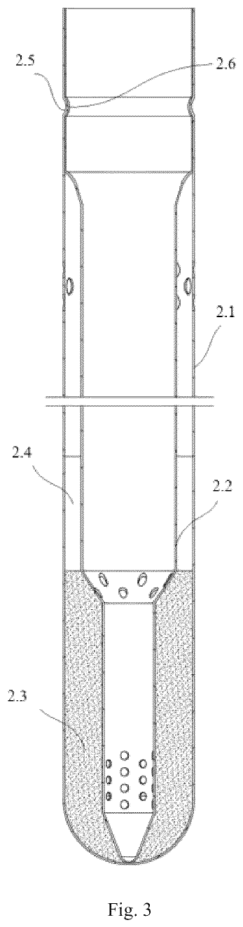

Referring to FIGS. 1-3, the housing comprises an outer sleeve 2.1, and an inner core 2.2. The housing 2.1 is tubular, wherein a head end of the outer sleeve 2.1 is enclosed, and a tail end of the outer sleeve 2.1 receives an inner core 2.2 to be inserted. The inner core 2.2 is tubular, wherein the inner core 2.2 comprises a front insertion segment 2.21 with an enclosed end, a rear insertion segment 2.22 with an open end, a tobacco containing space 2.3 is defined between the end of the front insertion segment 2.21 and the head end of the outer sleeve 2.1, an ventilation clearance 2.4 is formed between an outer wall of the front insertion segment 2.21 and an inner wall of the outer sleeve 2.1, an outer surface of the rear insertion segment 2.22 closely fits the inner wall of the outer sleeve 2.1, a plurality of inlet ports 2.11 are arranged on a side wall of the outer sleeve 2.1 to communicate with the ventilation clearance, and a plurality of vent holes 2.23 are arranged on the end of the front insertion segment 2.21 of the inner core 2.2. The inlet ports 2.11, the ventilation clearance 2.4, the vent holes 2.23, a conduit of the inner core 2.2 and the end of the rear insertion segment 2.22 of the inner core 2.2 form a smoke channel.

An outer side surface of the rear insertion segment 2.22 of the inner core 2.2 closely fits the inner side wall of the outer sleeve 2.1 through lock screw thread, the lock screw thread comprises a first groove 2.5 and a second groove 2.6 respectively disposed in the inner core 2.2 and the outer sleeve 2.1, and an inner side surface of the first groove 2.5 fits an outer side surface of the second groove 2.6 by shape.

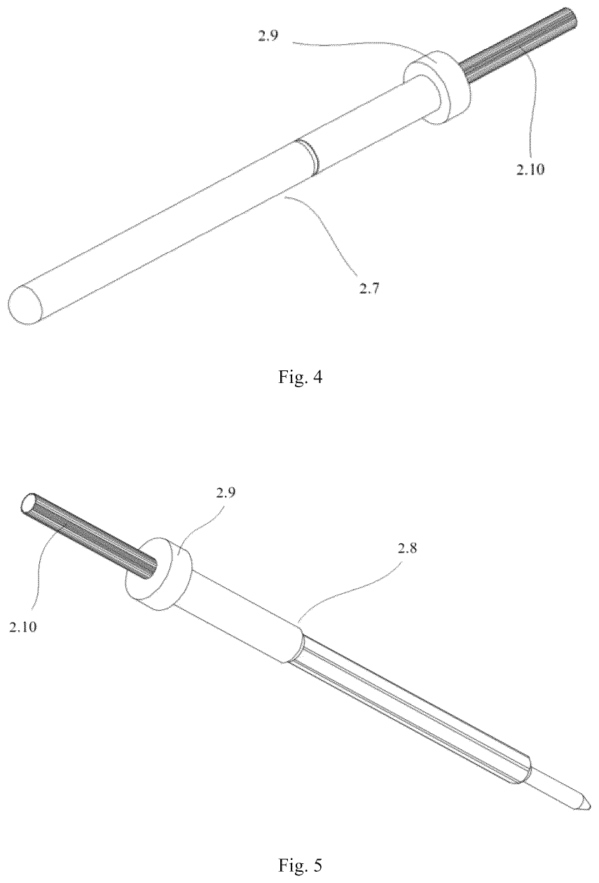

Referring to FIGS. 4-5, the gel dipping mold is manufactured by silicone, comprising a housing mold 2.7, an inner core mold 2.8, wherein the outer surface of the gel dipping mold corresponds to the inner wall of the housing. A fixing end 2.9 and a blind hole are disposed in the tail of the gel dipping mold, wherein the blind hole extends into the gel dipping mold through the fixing end 2.9, a pluggable hard core rod 2.10 is disposed inside the blind hole, a tail end of the hard core rod 2.10 is positioned outside of the gel dipping mold.

The outer sleeve 2.1 and the inner core 2.2 are transparent tubes.

The specific using procedure is: manufacturing of the housing comprises processing the outer sleeve 2.1 and the inner core 2.2 respectively, including followings steps:
Preparing the housing mold 2.7 and inner core mold 2.8 of the gel dipping mold suitable for the housing 2.1 and the inner core 2.2;
Preparing a liquid material for the housing;
Dipping, putting the gel dipping mold into the liquid material for the housing, then taking the gel dipping mold out, and drying and solidifying the gel dipping mold through a dehumidifier to form the housing;
Repeating dipping, putting the gel dipping mold into the liquid material for the housing again when the material for the housing on the outside of the gel dipping mold is solidified, and then taking the gel dipping mold out, and drying and solidifying the gel dipping mold through the dehumidifier to thicken the housing;
Repeating the repeating step of dipping three times, the generated housing is the outer sleeve or the inner core, the thickness of the housing is about 1 mm, meanwhile a first groove or a second groove is formed on the outer sleeve or the inner core;
Demolding, securing the fixing end 2.9 of the gel dipping mold, pushing the hard core rod 2.10 towards the blind hole, the gel dipping mold generating deforming elongation while an outer diameter is decreased by a pressure of the hard core rod 2.10, wherein the housing formed on the outside of the gel dipping mold does not deform with the gel dipping mold, so that the housing is demolded from the gel dipping mold.
Cutting the housing by a laser to remove a redundant length of the housing and perforating on a designated position of the housing to form the inlet ports 2.11 on the outer sleeve 2.1 or the vent holes 2.23 on the inner core 2.2.

After testing, the housing product can withstand high temperature of 350° C. while defects such as carbonization and air leakage will not occur.

In a new heat-not-burn cigarette composed of the outer sleeve 2.1 and the inner core 2.2, the tobacco shred is placed in the tobacco containing space 2.3, at the head end of the outer sleeve 2.1. When using a product of the invention, the outer sleeve 2.1 is inserted into a tubular heating chamber of the heater, the tobacco containing space 2.3 is totally inserted into the heater, the heater is switched on to heat the tobacco. When the smoker sucks, the air enters into the tobacco containing space 2.3 through the inlet port 2.11 and the ventilation clearance 2.4, and carries the smoke generated from the heated tobacco through the vent hole 2.23, the conduit of the inner core 2.2, and the end of the rear insertion segment 2.22 of the inner core 2.2, and then the air carrying the smoke is sucked by the smoker.

### Embodiment 2

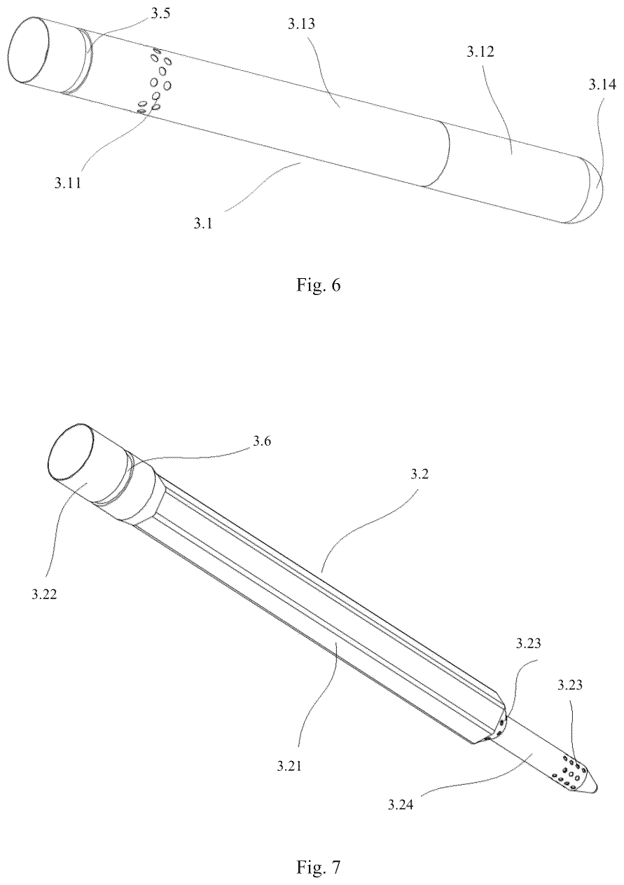

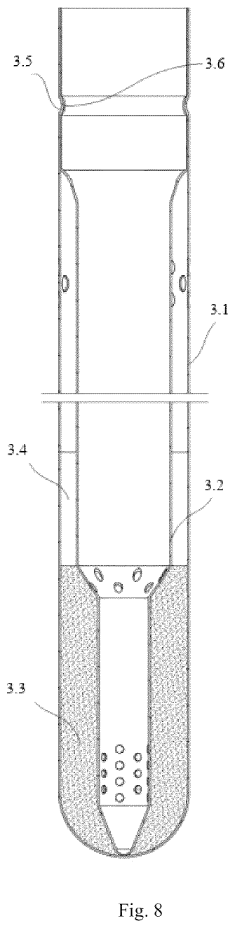

Referring to FIGS. 6-8, the present invention provides a technical solution:

A heat-not-burn cigarette comprises a housing 3.1 and an inner core 3.2. The housing 3.1 is tubular, a head end of the housing 3.1 is enclosed, and a tail end of the housing 3.1 receives an inner core to be inserted. The inner core 3.2 is tubular, and the inner core 3.2 comprises a front insertion segment 3.21 with an enclosed end, a rear insertion segment 3.22 with an open end, and a tobacco containing space 3.3 defined between the end of the front insertion segment 3.21 and the head end of the housing 3.1, wherein ventilation clearance 3.4 is defined between an outer wall of the front insertion segment 3.21 and an inner wall of the housing 3.1, and an outer surface of the rear insertion segment 3.22 closely fits the inner wall of the housing 3.1. A plurality of inlet holes 3.11 are provided in a side wall of the housing 3.1 to communicate with the ventilation clearance 3.4, a plurality of vent holes 3.23 are provided on the end of the front insertion segment 3.21 of the inner core 3.2, and the inlet holes 3.11, the ventilation clearance 3.4, the vent holes 3.23, a conduit of the inner core 3.2 and the end of the rear insertion segment 3.22 of the inner core 3.2 form a smoke channel.

The housing 3.1 comprises a heating portion 3.12 at the head end and a hand-held portion 3.13 at the tail end, and the heating portion 3.12 is fixedly connected with the hand-held portion 3.13.

A front end of the heating portion 3.12 of the housing 3.1 is provided with a hemispherical head cover 3.14, and an outside of the hand-held portion 3.13 is covered with a packing layer.

An end of the front insertion segment 3.21 of the inner core 3.2 is provided with a hollow tube tip 3.24 extending forward, and a tip of the hollow tube tip 3.24 is provided with a plurality of vent holes 3.23.

The front insertion segment 3.21 of the inner core 3.2 is a polygonal tube, and edges of the polygonal tube are in close contact with the inner wall of the housing 3.1.

An outer side surface of the rear insertion segment 3.22 of the inner core 3.2 closely fits the inner side wall of the housing 3.1 by locking screw thread, and the locking screw thread comprises a first groove 3.5 and a second groove 3.6 respectively provided in the inner core 3.2 and the housing 3.1. An inner side surface of the first groove 3.5 fits an outer side surface of the second groove 3.6 by shape.

The first groove 3.5 and the second groove 3.6 are annular grooves having arc-shaped cross-sections.

A mouthpiece is provided at an opening of the rear insertion segment 3.22 of the inner core 3.2. The housing 3.1 and the inner core 3.2 are transparent tubes.

The specific procedure is as follows: in a new heat-not-burn cigarette consisting of the housing 3.1 and the inner core 3.2, the tobacco shred is placed in the tobacco containing space 3.3; at the head end of the housing 3.1, at the time of using a product of the disclosure, the housing 3.1 is inserted into a tubular heating chamber of the heater, the tobacco containing space 3.3 is totally inserted into the heater; the heater is switched on to heat; when the smoker sucks, the air enters into the tobacco containing space 3.3 through the inlet hole 3.11 and the ventilation clearance 3.4, and carries the smoke generated from the heated tobacco through the vent hole 3.23, the conduit of the inner core 3.2, and the end of the rear insertion segment 3.22 of the inner core 3.2, and then the air carrying the smoke is sucked by the smoker.

The smoker can also attach a mouthpiece to the rear insertion segment 3.22 of the inner core 3.2 for suction.

### Embodiment 3

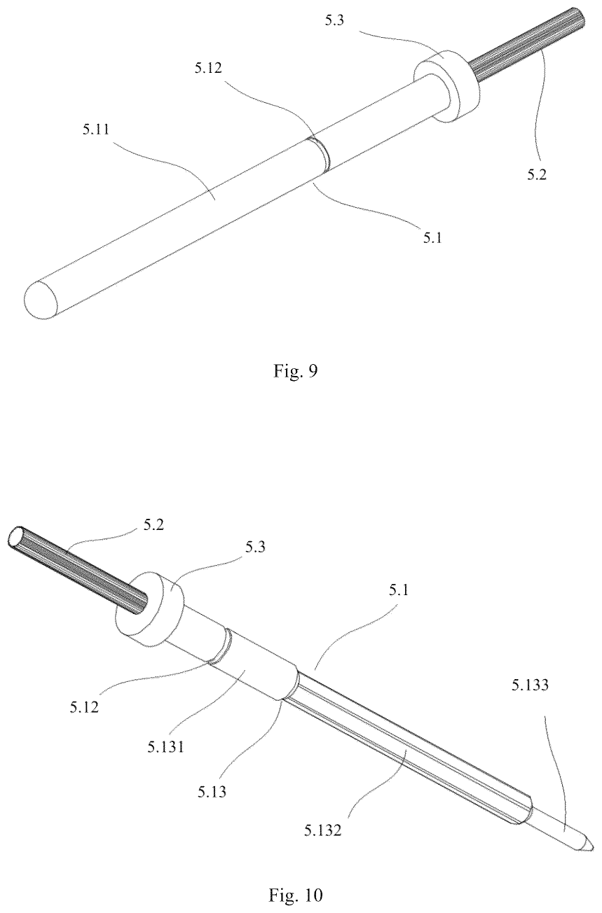

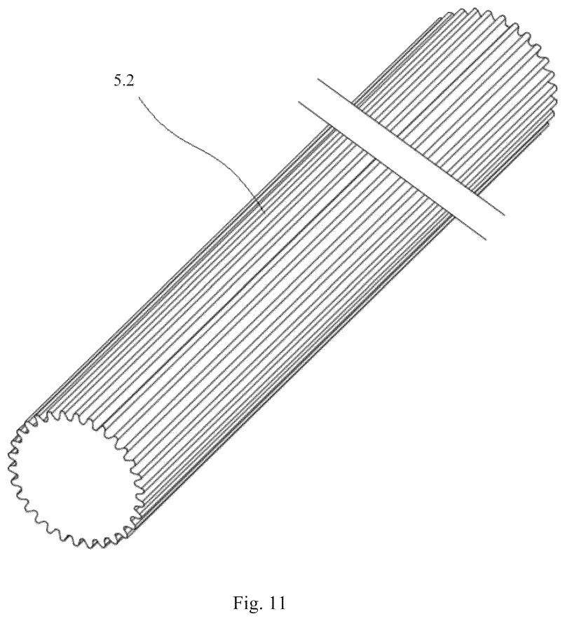

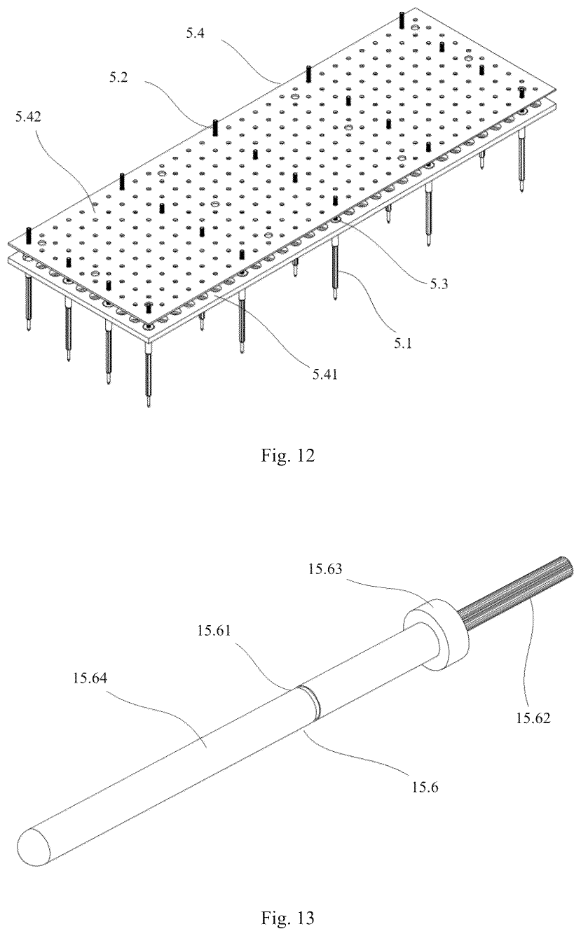

Referring to FIGS. 9-12, the present invention provides a technical solution as follows.

A gel dipping mold comprises an extendable a silicone mold body 5.1 and a core rod 5.2, wherein the silicone mold body 5.1 is elongated, and the silicone mold body 5.1 is provided with an axial long blind hole. One end of the silicone mold body 5.1 is enclosed, and another end of the silicone mold body is open and communicated with the long blind hole. The open end of the silicone mold body 5.1 comprises a mounting boss 5.3, and the out diameter of the core rod 5.2 matches the diameter of the long blind hole. One end of the core rod 5.2 is arranged in the long blind hole, and another end of the core rod 5.2 is arranged outside of the silicone mold body 5.1.

The silicone mold body 5.1 is a silicone outer sleeve mold 5.11, wherein the silicone outer sleeve mold 5.11 has a shape of circular tube, and the enclosed end of the silicone outer sleeve mold 5.11 is hemispheric, and the outer surface of the silicone outer sleeve mold 5.11 proximate to the open end comprises an annular groove 5.12.

The silicone mold body 5.1 is a silicone inner core mold 5.13, and the silicone inner core mold 5.13 comprises a circular tube segment 5.131 connected with the open end. A polygon tube segment 5.132 connected with the enclosed end, an end face of the enclosed end comprises a pointed cone segment 5.133 extending outwardly along an axis direction; and the outer surface of the circular tube segment 5.131 comprises an annular groove 5.12.

The core rod 5.2 is cylindrical, and the circumferential side surface of the core rod 5.2 is provided with a plurality of grooves having an orientation same as an axial direction and recessed inwardly, wherein the grooves comprise lubricating fillers therein.

The gel dipping mold comprises a mold fixing mount 5.4, and the mold fixing mount 5.4 comprises a fixing plate 5.41 and a cover plate 5.42 coupled with each other. A plurality of the mounting bosses 5.3 of the silicone mold body 5.1 is secured between the fixing plate 5.41 and the cover plate 5.42, and one end of the core rod 5.2 traverses the cover plate 5.42 and is positioned outside of the fixing mount 5.4.

The specific procedure is as follows: securing a plurality of silicone outer sleeve molds 5.11 or silicone inner core molds 5.13 to the mold fixing mount 5.4. In particular, an end of the silicone outer sleeve mold 5.11 or an end of the silicone inner core mold 5.13 traverses the fixing plate 5.41, and the mounting boss 5.3 is obstructed by the annular groove of the fixing plate 5.41 and cannot traverse the fixing plate 5.41. When all the silicone outer sleeve molds 5.11 and silicone inner core molds 5.13 are disposed in place, the cover plate 5.42 traverses an exposed end of the core rod 5.2 and presses the fixing mount 5.41 and the mounting boss 5.3. The cover plate 5.42 is secured to the fixing plate 5.41, then the production can be processed.

During production, the part of the silicone outer sleeve mold 5.11 or the part of the silicone inner core mold 5.13 positioned below the mold fixing mount 5.4 is dipped into a raw liquid gel material. The liquid gel is sticked to the surface of the silicone outer sleeve mold 5.11 or the silicone inner core mold 5.13, and then the liquid gel is dried to form a semi-finished housing sticking to an outer surface of the silicone outer sleeve mold 5.11 or the silicone inner core mold 5.13. And then an axial force to the core rod 5.2 of the silicone outer sleeve mold 5.11 or the silicone inner core mold 5.13 is applied, such that the silicone outer sleeve mold 5.11 or the silicone inner core mold 5.13 is deformed and stretched, thereby the semi-finished not deformed is demolded. The demolded semi-finished housing is processed to form an outer sleeve product or the inner core product. After demolding, the axial force applied to the core rod 5.2 is removed, and the silicone outer sleeve mold 5.11 or the silicone inner core mold 5.13 bounces back to its original shape.

### Embodiment 4

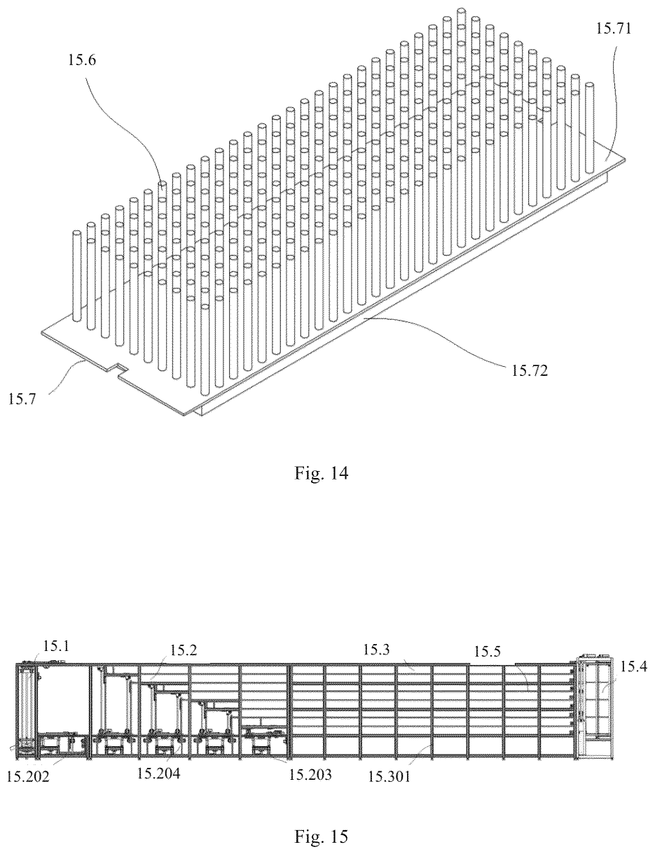

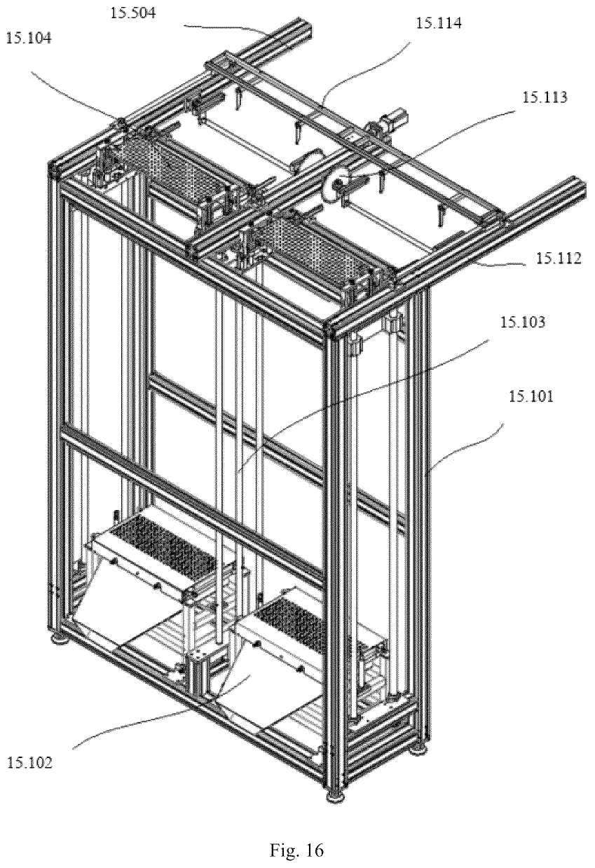

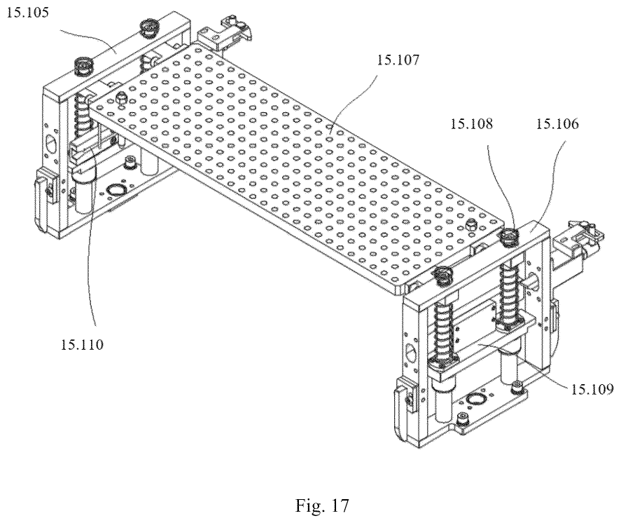

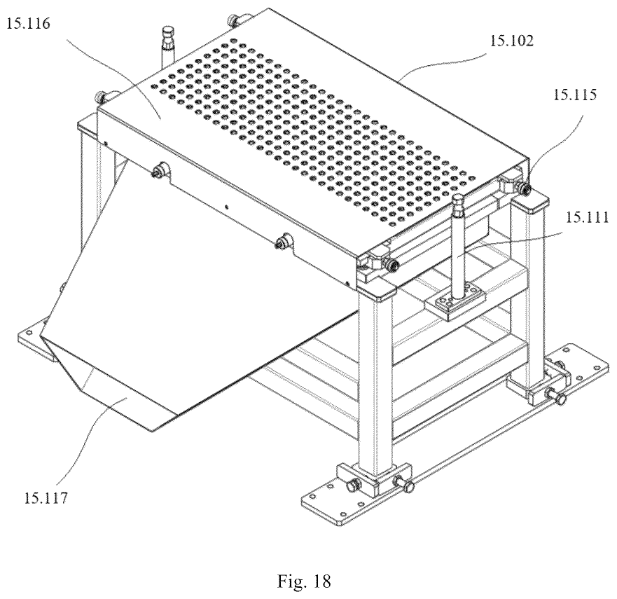

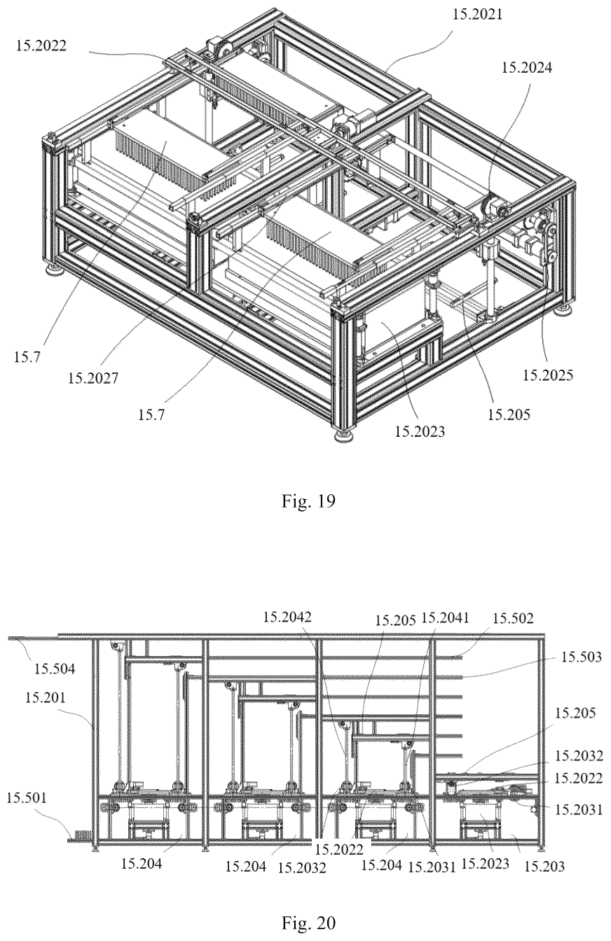

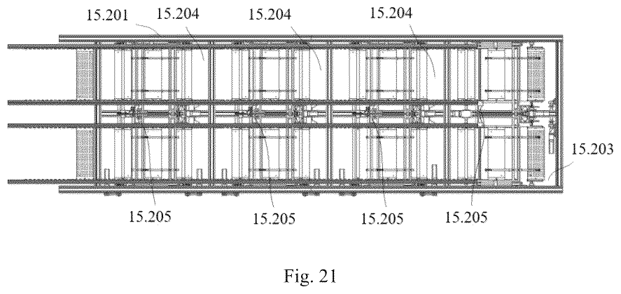

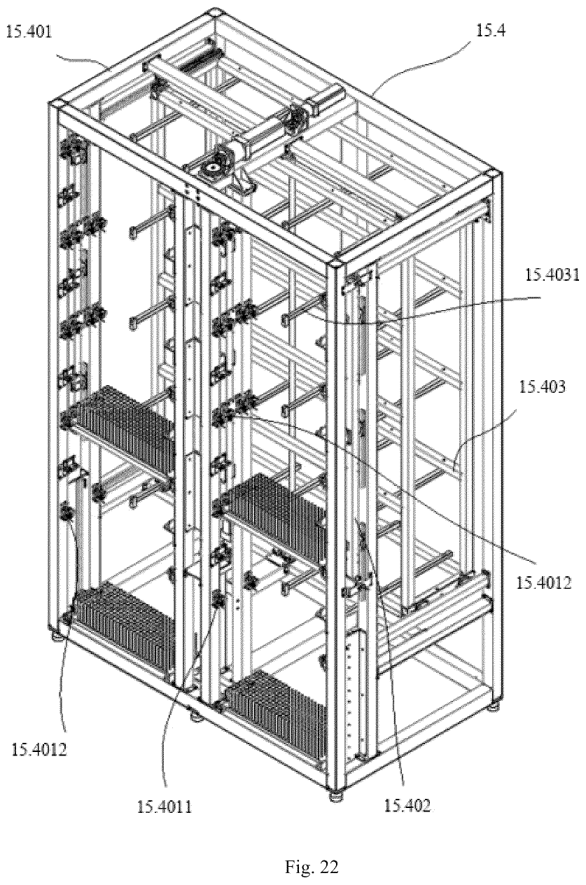

Please refer to accompanying FIGS. 13-22, a technical solution is provided:

A multiple continuous gel dipping device comprises a drafting device 15.1, a multiple gel dipping device 15.2, a drying device 15.3, a tail lifting device 15.4, which are arranged in a straight line, and also comprises continuous conveying devices 15.5 disposed between the above devices, and a tray 15.7 carrying a plurality of gel dipping molds 15.6. The gel dipping mold 15.6 includes a mold body 15.61 and a core rod 15.62, and the mold body 15.61 is a strip-shaped retractable mold, including a fixed end 15.63, a dipping end 15.64, and a blind hole open at the fixed end. The fixed end 15.63 is fixed on the tray 15.7, the gel dipping end 15.64 is on the outside of the tray 15.7, one end of the core rod 15.62 is inserted into the blind hole, and the other end of the core rod 15.62 is on the outside of the tray 15.7. The drafting device 15.1 includes a drafting rack 15.101 including a tray lifting device therein, and a receiving device 15.102 is disposed at the bottom of the drafting rack 15.101. The tray lifting device includes screw lifting devices 15.103 and a drafting ejection device 15.104, and the ejection device 15.104 includes a left ejection rack 15.105, a right ejection rack 15.106, and a draft ejection plate 15.107. The two ends of the draft ejection plate 15.107 are respectively fixed to the left ejection rack 15.105 and the right ejection rack 15.106. The left ejection rack 15.105 and the right ejection rack 15.106 respectively include guide posts 15.107, springs 15.108, and a draft ejection tray plate 15.109 with a moving groove that allows insertion of the both ends of the tray 15.7. When the tray 15.7 is in the moving groove 15.110, the gel dipping end 15.64 of the mold body 15.61 is under the tray 15.7, the draft ejection tray plate 15.109 is movably connected to guide posts 15.107, the guide posts pass through the springs 15.108, and one end of the spring 15.108 is closely fixed with the draft ejection tray plate 15.109. The receiving device 15.102 includes an ejection device stopping rod 15.111, and the draft ejection device 15.104 includes working positions at the top and bottom of the screw lifting device 15.103. The tray 15.7 is inserted in the moving groove 15.110 when the draft ejection device 15.104 is at the top working position of the screw lifting device 15.103. The draft ejection tray plate 15.109 is held up by an ejection device stopping rod 15.111, and the left ejection rack 15.105 and the right ejection rack 15.106 continue to descend to a predetermined position when the draft ejection device 15.104 is lowered to the bottom working position of the screw lifting device 15.103.

At one side of the drafting rack 15.101, a multiple gel dipping device 15.2, a drying device 15.3, and a tail lifting device 15.4 are sequentially arranged. The multiple gel dipping device 15.2 includes gel dipping rack 15.210, a first gel dipping device 15.202, a second gel dipping device 15.203, and a plurality of repeated gel dipping and lifting devices 15.204. The first gel dipping device 15.201 is at one side of the gel dipping rack 15.201 close to the drafting rack 15.101, the second gel dipping device 15.202 is at the other side of the gel dipping rack 15.201 away from the drafting rack 15.101, and the plurality of repeated gel dipping and lifting devices are disposed between the first gel dipping device 15.202 and second gel dipping device 15.203. The first gel dipping device 15.202, the second gel dipping device 15.203, and the plurality of gel dipping device respectively includes a tray pushing device 15.205. The drying device 15.3 includes a drying rack 15.301 with a multi-layer drying area, and the multi-layer drying area corresponds to the first gel dipping device 15.202, the second gel dipping device 15.203, and the plurality of repeated gel dipping and lifting device layer by layer. The continuous convey device 15.5 includes multi-layer tracks, and the first gel dipping device 15.202 is connected to the drying area and the tail lifting device 15.4 through the bottom track 15.501 at the bottom of the gel dipping rack 15.201 and the drying rack 15.301. The second gel dipping device 15.203 and the plurality of repeated gel dipping and lifting device 15.205 are respectively connected to the drying area and the tail lifting device 15.4 through the upper track 15.502 and the lower track 15.503. A top track 15.504 is disposed at the top of the gel dipping rack 15.201 and the track pushing device, and the tray 15.7 with gel dipping molds 15.6 is moveable on the multi-layer tracks. The tail lifting device 15.4 includes a lifting rack 15.401 comprising a tail tray lifting rack 15.402 that moves up and down, and a tail tray push rack 15.403 that moves lift and right, and the tail tray lifting rack 15.402 includes tray support components that correspond to the multi-layer tracks.

An extension arm 15.112 extending outwards is disposed at the top of the drafting rack 15.101 includes. The extension arm 15.112 includes a top tray turning device 15.113 that corresponds to the tail lifting device 15.4 through the top track 15.504, and a top tray pushing device 15.114. The top tray turning device 15.113 turns the tray 15.7 by 180 degrees, so that the gel dipping end 15.64 of the mold body 15.61 is under the tray 15.7, and the top tray pushing device 15.114 moves the tray 15.7 to the draft ejection tray plate 15.109. The multiple dipping device 15.2 includes a first gluing device 15.202 comprising a gel dipping frame 15.2021 that is under the extension arm 15.112, and the top of the gel dipping frame 15.2021 is provided with a tray translation device 15.2022. When the draft ejection device 15.104 of the drafting rack 15.101 is at the bottom working position of the screw lifting device 15.103, the tray translation device 15.2022 moves the tray 15.7 from the draft ejection tray plate 15.109 to the gel dipping frame 15.2021.

The first gel dipping device 15.202 includes a liftable gel reservoir 15.2023, a tray translation device 15.2022, a primary tray turning device 15.2024, a tray lowering device 15.2025, and a tray pushing device 15.205. The tray translation device 15.2022 includes a moving rod assembly 15.2027 that moves the tray 15.7 from the draft ejection tray plate 15.109 to a position above the liftable gel reservoir 15.2023, and at the same time moves the other tray 15.7 from the position above the liftable gel reservoir 15.2023 to the primary tray turning device 15.2024. The primary tray turning device 15.2024 turns the tray 15.7 by 180 degrees so that the gel dipping end 15.64 of the mold body 15.61 is above the tray 15.7, and the tray lowering device 15.2025 moves the tray 15.7 to the tray pushing device 15.205, and the tray pushing device 15.205 moves the tray 15.7 onto the bottom track 15.501. One end of the bottom track 15.501 is matched with the tray pushing device 15.205, and the other end of the bottom track 15.501 is matched with the tail tray lifting rack 15.402 with the drying area.

The second gel dipping device 15.203 includes a primary tray turning device 15.2031, a tray translation device 15.2022, a liftable gel reservoir 15.2023, a secondary tray turning device 15.2032, and a tray pushing device 15.205 that moves the tray 15.7 to the primary tray turning device 15.2031 through the lower track 15.503. The primary tray turning device 15.2031 turns the tray 15.7 by 180 degrees so that the gel dipping end 15.64 of the mold body 15.61 is under tray 15.7. The tray translation device 15.2022 moves the tray 15.7 to a position above the liftable gel reservoir 15.2023, and at the same time moves the tray 15.7 from the position above the liftable gel reservoir 15.2023 to the secondary tray turning device 15.2032. The secondary tray turning device 15.2032 turns the tray 15.7 by 180 degrees so that the gel dipping end 15.64 of the mold body 15.61 is above the tray 15.7, and the tray pushing device 15.205 moves the tray 15.7 to the upper track 15.502. One end of the lower track 15.502 is matched with the tray pushing device 15.205 of the second gel dipping device 15.203, and the other end of the lower track 15.502 that passes through the drying area is matched with the tail tray lifting rack 15.402. One end of the lower track 15.503 corresponds to the tail tray push rack 15.403, and the other end of the lower track 15.503 corresponds to the primary turning device 15.2031 of the second gel dipping device 15.203 through the drying area.

The multiple repeated gel dipping and lifting devices 15.204 respectively include a primary tray turning device 15.2031, a tray lowering device 15.2041, a tray translation device 15.2022, a liftable gel reservoir 15.2023, a tray lifting device 15.2042, and a secondary tray turning device 15.2032, and a tray pushing device 15.205. The tail tray push rack 15.403 moves the tray 15.7 to the primary tray turning device 15.2031 through the lower track 15.503, and the primary tray turning device 15.2031 turns the tray 15.7 by 180 degrees to move the gel dipping end 15.64 of the mold body 15.61 under the tray 15.7. The tray lowering device 15.2041 lowers the tray 15.7 to the tray translation device 15.2022, and the tray translation device 15.2022 moves the tray 15.7 to a position above the liftable gel reservoir 15.2023, and at the same time the tray translation device 15.2022 moves the other tray 15.7 from the position above the liftable gel reservoir 15.2023 to the tray lifting device 15.2042. The tray lifting device 15.2042 lifts the tray 15.7 to the secondary tray inversion device 15.2032, and the secondary tray turning device 15.2032 turns the tray 15.7 by 180 degrees so that the gel dipping end 15.64 of the mold body 15.61 is above the tray 15.7, and the tray pushing device 15.205 moves the tray 15.7 to the upper track 15.502. One end of the upper track 15.502 corresponds to the tray pushing device 15.205 of the plurality of repeated gel dipping and lifting devices 15.204, and the other end of the upper track 15.502 fits the tail tray lifting rack 15.402 through the drying area. One end of the lower track 15.503 corresponds to the tail tray push rack 15.403, and the other end passes through the drying area and corresponds to the primary tray turning device 15.2031 of the plurality of repeated gel dipping and lifting devices 15.204.

The plurality of repeated gel dipping and lifting devices 15.204 are provided with three repeated gel dipping and lifting devices.

The tail tray push rack 15.403 includes tail pushing rod assemblies 15.4031 corresponding to the top track 15.504, the second gel dipping device 15.203, and the lower track 15.503 of the plurality of repeated gel dipping and the lifting devices 15.204. At the corresponding connection sites between the lifting rack 15.401 and the bottom track 15.501 and the upper track 15.502, a fixed tray plate 15.4011 is provided, and the corresponding connection of the lifting tack 401 with the lower track 15.503 and the top track 15.504 includes an upwardly rotatable and resettable rotary reset tray plate 15.4012. The tail tray lifting rack 15.402 is provided with a rotary reset tray 15.4012 that is matched with a fixed tray 15.4011 on the lifting rack 15.401. The tail tray lifting rack 15.402 lifts the tray 15.7 entering from the bottom track 15.503 or the top track 15.504 to a position corresponding to the lower track 15.503 or top track 15.504, and the tail tray pushing rack 15.403 pushes the tray 15.7 into the lower track 15.503 or the top track 15.504.

The tray 15.7 includes a fixed plate 15.71 and a cover plate 15.72, and the fixed ends 15.63 of a plurality of silicone mold bodies 15.61 (installation bosses) are fixed between the fixed plate 15.71 and the cover plate 15.72. One end of the core rod 15.62 passes through the cover plate 15.72 to be outside of the tray 15.7.

The receiving device 15.102 is provided with the guide wheels 15.115 of the draft ejection device 15.104, a draft blanking box 15.116, and a draft outlet 15.117.

The specific use process is as follows: fixing a plurality of mold bodies 15.61 on the tray 15.7, specifically, passing the gel dipping end 15.64 of the mold body 15.61 through the fixed plate 15.71, wherein the fixed end 15.63 (installation boss) is blocked by the fixed plate 15.71 and cannot pass the fixed plate 15.71; after all the mold bodies 15.61 are in place, passing the cover plate 15.72 through the exposed end of the core rod 15.62, wherein the cover plate 15.72 presses against the fixing plate 15.71 and the fixed end 15.63 (installation boss) and fixing the cover plate 15.72 and the fixing plate 15.71 firmly for the production.

The mold bodies 15.61 are dipped for the first time in the first gel dipping device 15.202 during production. At this time, the gel dipping ends 15.64 of the mold bodies 15.61 are under the tray 15.7, and the gel dipping ends 15.64 of the mold bodies 15.61 are dipped into the liftable gel reservoir 15.2023 to allow the gel to adhere to the surface of the gel dipping ends 15.64 of the mold bodies 15.61. Then, the tray 15.7 with the mold bodies 15.61 is turned by 180 degrees so that the gel dipping ends 15.64 of the mold bodies 15.61 are on the tray 15.7 to prevent the gel drop from falling. The first gel dipping device 15.202 pushes the tray 15.7 with the mold bodies 15.61 from the bottom track 15.501 through the drying device 15.3 into the tail lifting device 15.4, and the tail tray lifting rack 15.402 lifts the tray 15.7 with the mold bodies 15.61 from the bottom track 15.501 to the lower track 15.503 that is matched with the second gel dipping device 15.203.

The tail tray push rack 15.403 moves the tray 15.7 with the mold bodies 15.61 from the lower track 15.503 through the drying device 15.3 to the second gel dipping device 15.203 and turns the tray 15.7 with the mold bodies 15.61 so that the gel dipping ends of the mold bodies is under the tray 15.7. Then, the gel dipping ends 15.64 of the mold bodies 15.61 are dipped in the gel reservoir 15.2023 for the second time, and are translated and turned over for the second time, the gel dipping ends 15.64 of the mold bodies 15.61 are above the tray 15.7. The second gel dipping device 15.203 sends the tray 15.7 with mold bodies 15.61 to the upper track 15.502 which is matched with the second gel-dipping device 15.203. The tray pushing device 15.205 of the second gel-dipping device moves the tray 15.7 with mold bodies 15.61 from the upper track 15.502 through the drying device 15.3 into the tail lifting device 15.4, and the tail tray lifting rack 15.402 lifts the tray 15.7 with the mold bodies 15.61 from the upper track 15.502 to the lower track 15.503 that is matched with the repeated gel dipping and lifting device 15.204 at the lowest position among the plurality of repeated dipping and lifting devices 15.204.

The tail tray pushing device 15.403 moves the tray 15.7 with the mold body 15.61 from the lower track 15.503 through the drying device 15.3 to the repeated dipping and lifting device 15.204, and turns the tray 15.7 with the mold body 15.61 so that the gel dipping end 15.64 of the mold body 15.61 is under the tray 15.7, then the tray lowering device 15.2041 lowers the tray 15.7 to the tray translation device 15.2022. The tray translation device 15.2022 moves the tray 15.7 to a position above the liftable gel reservoir 15.2023 while the other tray moves from the position above the liftable gel reservoir 15.2023 to the tray lifting device 15.2042. The tray lifting device 15.2042 lifts the tray 15.7 to the secondary tray turning device 15.2032, and the secondary tray turning device 15.2032 turns the tray 15.7 by 180 degrees so that the gel dipping end 15.64 of the mold body 15.61 is above the tray 15.7. The tray pushing device 15.205 moves the tray 15.7 to the upper track 15.502 and passes the tray 15.7 from the upper track 15.502 through the drying device 15.3 into the tail lifting device 15.4, and the tail tray lifting rack 15.402 lifts the tray 15.7 with the mold bodies 15.61 from the position of the upper track 15.502 to the lower track 15.503 that is matched with the repeated dipping and lifting device 15.204 of the upper layer.

After repeating the above process for many times, the repeated dipping and lifting device 15.204 at the highest position moves the tray 15.7 with the mold bodies 15.61 into the tail lifting device 15.4, the tail tray lifting rack 15.402 lifts the tray 15.7 with mold bodies 15.61 to the position of the top track 15.504, and the tail tray push rack 15.403 pushes the tray 15.7 with mold bodies 15.61 to the top of the drafting device 15.1. The gel dipping ends 15.64 of the mold body 15.61 are above the tray 15.7 at that time. The top tray turning device 15.113 of the drafting device 15.1 is turned over once so that the gel dipping ends 15.64 of the mold bodies 15.61 are under the tray 15.7, and then the top tray pushing device 15.114 pushes the tray 15.7 with the mold bodies 15.61 into the draft ejection device 15.104 of the ejection device 15.1.

At the time of demolding, the tray 15.7 with the mold bodies 15.61 is lowered to the demolding working position along with the draft ejection device 15.104 on the screw lifting device 15.103. At this time, the draft ejection tray plate 15.109 is abutted by an ejection device stopping rod 15.111 while the left ejection rack and the right ejection rack are descending. The draft ejection plate 15.107 fixed on the left ejection rack 15.105 and the right ejection rack 15.106 is pressed onto the upper tail end of the core rod 15.62 of the mold body 15.61 and moves the core rod 15.62 downward. The mold bodies 15.61 extend downward, and the adhesion force between the products that surround the outer side of the silicone mold bodies 15.61 and the mold bodies 15.61 are destroyed to detach the products from the mold bodies 15.61 and realize demolding.

After demolding, tray 15.7 with the mold bodies 15.61 is brought into the first gel dipping device 15.202 by the moving rod assembly 15.2027 of the tray translation device 15.205 of the first gel dipping device 15.202, and then the screw lifting device 15.103 drives the ejection device 15.104 to return to the top of the draft device 15.1. The tray 15.7 with the mold bodies 15.61 repeats the production process consisting of dipping, drying, and demolding for many times.

Although embodiments of the present invention have been shown and described, it will be understood by those skilled in the art that various changes, modifications, substitutes and variants can be made in these embodiments without departing from the principle and spirit of the invention, the scope of the present invention is defined by the appended claims and their equivalents.

1. A material for a heat-not-burn capsule housing, the material comprising:
plant cellulose, microcrystalline cellulose, water, and alcohol in a form of a liquid mixture, a weight proportion of the plant cellulose to the microcrystalline cellulose being between 10:1 to 80:1, the liquid mixture including 10 parts by weight of a combination of the plant cellulose and the microcrystalline cellulose, 50 parts by weight of water, and 50 parts by weight of 99% alcohol.

2. The material of claim 1, wherein the liquid mixture is a result of the combination of the plant cellulose and the microcrystalline cellulose being added to water that is heated to 90° C. followed by stirring for 1 hour and then standing at a temperature between 30 to 60° C. for 2 hours.

3. The material of claim 2, wherein the liquid mixture is the result of the 99% alcohol being added after the water and homogenized.

4. The material of claim 2, wherein the weight proportion of the plant cellulose to the microcrystalline cellulose is 50:1, and the temperature during the standing is 45° C.

5. A method of manufacturing a heat-not-burn capsule housing, the method comprising:
providing a liquid mixture including plant cellulose, microcrystalline cellulose, water, and alcohol, a weight proportion of the plant cellulose to the microcrystalline cellulose being between 10:1 to 80:1;
immersing a dipping mold into the liquid mixture, the dipping mold including an elastic body and a core rod seated within the elastic body;
removing the dipping mold from the liquid mixture;
drying a layer of the liquid mixture on an exterior of the dipping mold to form an initial shell;
repeating the immersing, the removing, and the drying at least one time to obtain a subsequent shell;
elongating the elastic body of the dipping mold with the core rod so as to reduce an outer diameter of the dipping mold and release the subsequent shell; and
cutting and perforating the subsequent shell with a laser to obtain the heat-not-burn capsule housing.

6. A closed bottom capsule comprising:
an outer sleeve including a first end and a second end, the second end being a closed end and defining an aerosol-generating material space, the outer sleeve further including a plurality of first apertures, the first plurality of apertures providing at least one air inlet, the at least one air inlet being in fluid communication with the aerosol-generating material space; and
an inner sleeve at least partially in the outer sleeve, the inner sleeve including a plurality of second apertures, the aerosol-generating material space being further defined by a spacing between the outer sleeve and the inner sleeve, the plurality of second apertures providing at least one outlet for an aerosol to exit the aerosol-generating material space.

7. The closed bottom capsule of claim 6, wherein a portion of the inner sleeve is between the plurality of first apertures and the first end of the outer sleeve.

8. The closed bottom capsule of claim 7, wherein the portion of the inner sleeve contacts the outer sleeve.

9. The closed bottom capsule of claim 8, further comprising:
a mouthpiece at an end of the inner sleeve.

10. The closed bottom capsule of claim 6, wherein the inner sleeve includes a plurality of third apertures spaced from the plurality of second apertures, the plurality of third apertures are on an angled portion of the inner sleeve, the angled portion being angled with respect to a longitudinal axis of the inner sleeve, and the plurality of second apertures and the plurality of third apertures are between the plurality of first apertures and the second end of the outer sleeve.
